(19) United States
(12) Patent Application Publication
(10) Pub. No.: US 2026/0105526 A1
(43) Pub. Date: Apr. 16, 2026

(54) INFORMATION PROCESSING APPARATUS, SUPPORT METHOD, AND NON-TRANSITORY COMPUTER-READABLE MEDIUM

(71) Applicant: NEC Corporation, Tokyo (JP)

(72) Inventors: Takuma SATO, Tokyo (JP); Daiki SATO, Tokyo (JP); Fumihiro TANIGUCHI, Tokyo (JP); Etsuko ICHIHARA, Tokyo (JP); Kenei TANABE, Tokyo (JP)

(73) Assignee: NEC Corporation, Tokyo (JP)

(21) Appl. No.: 19/347,026

(22) Filed: Oct. 1, 2025

(30) Foreign Application Priority Data
Oct. 11, 2024 (JP) 2024-179346

(51) Int. Cl. G06Q 40/06; G06F 16/35

(52) U.S. Cl. CPC G06Q 40/066; G06F 16/35

(57) ABSTRACT

An information processing apparatus includes a classification unit that classifies a plurality of pieces of numerical data related to a life plan of a subject into data items for generating support information of life planning using content information indicating content of each piece of numerical data and a language model, and a support information generation unit that generates support information using the numerical data as data of a data item classified by the classification unit. The information processing apparatus supports the decision making of the subject.

### INCORPORATION BY REFERENCE

This application is based upon and claims the benefit of priority from Japanese patent application No. 2024-179346, filed on Oct. 11, 2024, the disclosure of which is incorporated herein in its entirety by reference.

### TECHNICAL FIELD

The present disclosure relates to an information processing apparatus, a support method, and a non-transitory computer-readable medium.

### BACKGROUND ART

Recently, interest in life planning has increased. In the life planning, a life plan including a fund plan from the present to the future is created based on the current assets held by the subject, the status of revenue and expenditure, the family structure, the future design, and the like.

An example of a technique for supporting life planning is an information processing system disclosed in WO 2020/170375 A1. In the information processing system disclosed in WO 2020/170375 A1, future prediction is performed for each of the health asset and the economic asset of the subject, and information regarding options that can be selected by the subject is generated based on the prediction results.

### SUMMARY

The information processing system disclosed in WO 2020/170375 A1 uses data obtained by quantifying the total amount of economic assets such as money, land, buildings, and securities belonging to the subject in order to predict the future of the economic assets. However, it takes time and effort to prepare such data. Specifically, in order to create data obtained by quantifying the total amount of economic assets, the subject is forced to perform complicated work of classifying current revenue and expenditure into salary income, housing expenses, and the like and aggregating the amount of money for each classification while confirming the deposit/withdrawal statement in the subject's account. As described above, the information processing system disclosed in WO 2020/170375 A1 has room for improvement in that the burden of manual work in life planning is large.

The present disclosure has been made in view of the above problems, and an example object thereof is to provide a technique capable of reducing a burden of manual work in life planning.

An information processing apparatus according to an example aspect of the present disclosure includes classification means for classifying a plurality of pieces of numerical data related to a life plan of a subject into data items for generating support information for supporting life planning of the subject by using content information indicating content of each piece of numerical data and a language model trained by machine learning on natural language, and support information generation means for generating the support information by using the numerical data as data of data items classified by the classification means.

A support method according to an example aspect of the present disclosure causes at least one processor to execute classification processing for classifying a plurality of pieces of numerical data related to a life plan of a subject into data items for generating support information for supporting life planning of the subject by using content information indicating content of each piece of numerical data and a language model trained by machine learning on natural language, and support information generation processing for generating the support information by using the numerical data as data of data items classified by the classification processing.

A support program according to an example aspect of the present disclosure causes a computer to function as classification means for classifying a plurality of pieces of numerical data related to a life plan of a subject into data items for generating support information for supporting life planning of the subject by using content information indicating content of each piece of numerical data and a language model trained by machine learning on natural language, and support information generation means for generating the support information by using the numerical data as data of data items classified by the classification means.

According to an exemplary aspect of the present disclosure, there is an exemplary effect that a burden of manual work in life planning can be reduced.

### BRIEF DESCRIPTION OF DRAWINGS

FIG. 1 is a block diagram illustrating a configuration of an information processing apparatus according to the present disclosure;

FIG. 2 is a flowchart illustrating a flow of a support method according to the present disclosure;

FIG. 3 is a diagram illustrating an example of processing executed by another information processing apparatus according to the present disclosure;

FIG. 4 is a block diagram illustrating a configuration of an information processing apparatus illustrated in FIG. 3;

FIG. 5 is a diagram illustrating an example of a prompt generated by a classification unit and an inference result obtained by inputting the prompt into a language model;

FIG. 6 is a diagram for explaining presentation and reclassification of inference results;

FIG. 7 is a flowchart illustrating a flow of processing executed by the information processing apparatus illustrated in FIG. 3; and

FIG. 8 is a block diagram illustrating a configuration of a computer functioning as the information processing apparatus according to the present disclosure.

### EXAMPLE EMBODIMENT

Hereinafter, example embodiments of the present invention will be described. However, the present invention is not limited to the exemplary example embodiments to be described below, and various modifications can be made within the scope described in the claims. For example, example embodiments obtained by appropriately combining techniques (some or all of things or methods) adopted in the following exemplary example embodiments can also be included in the scope of the present invention. Example embodiments obtained by appropriately omitting some of the techniques adopted in the following exemplary example embodiments can also be included in the scope of the present invention. Effects mentioned in the following exemplary example embodiments are examples of effects expected in the exemplary example embodiments, and do not define extensions of the present invention. That is, example embodiments that do not achieve the effects mentioned in the following exemplary example embodiments can also be included in the scope of the present invention.

### First Exemplary Example Embodiment

A first exemplary example embodiment that is an example of an example embodiment of the present invention will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in the other exemplary example embodiments included in the present disclosure within a range in which no particular technical problem occurs. Each technique illustrated in the drawings referred to for describing the present exemplary example embodiment can also be adopted in the other exemplary example embodiments included in the present disclosure within a range in which no particular technical problem occurs.

### (Configuration of Information Processing Apparatus 1)

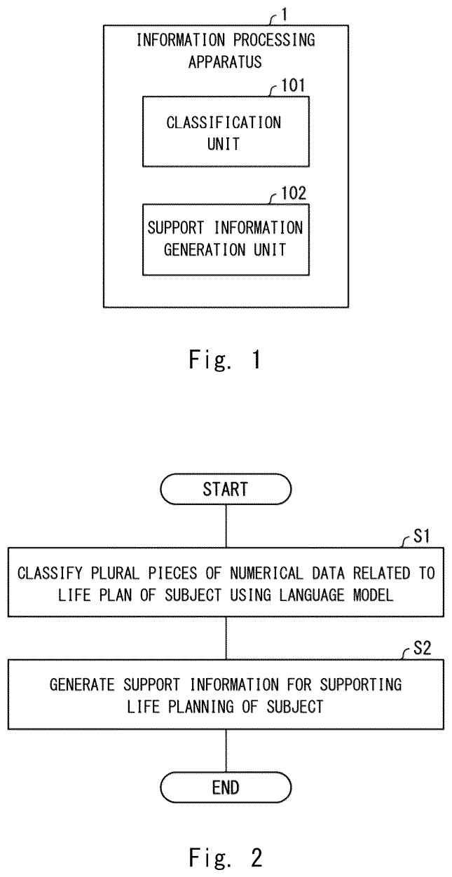

A configuration of an information processing apparatus 1 according to the present exemplary example embodiment will be described with reference to FIG. 1. FIG. 1 is a block diagram illustrating a configuration of the information processing apparatus 1. As illustrated in FIG. 1, the information processing apparatus 1 includes a classification unit 101 and a support information generation unit 102.

The classification unit 101 classifies a plurality of pieces of numerical data related to the life plan of the subject into data items for generating support information for supporting the life planning of the subject by using content information indicating content of each piece of numerical data and a language model trained by machine learning on a natural language.

The plurality of pieces of numerical data related to the life plan may be any data used for generating the support information. The content information may indicate the content of each piece of numerical data. For example, a deposit/withdrawal statement (which can also be referred to as a deposit/withdrawal history) in a bank account or a securities account held by the subject includes numerical data such as an amount of deposit, an amount of withdrawal, and an account balance, and also includes text data indicating contents thereof. Therefore, the classification unit 101 can classify numerical data indicated in the deposit/withdrawal statement by using text data indicated in the deposit/withdrawal statement. The classification unit 101 can also classify numerical data obtained from, for example, a credit card statement, a transaction history of electronic money, a public utility bill payment statement, a medical bill, numerical data extracted from a receipt, a personal number card, a withholding certificate, a tax return, a tax payment certificate, a certificate of taxation, a loan balance certificate, and the like. Specific examples of the numerical data include the amount of money deposited, the amount of money withdrawn, the account balance, the expenditure amount, the income amount, the amount of tax payment, the amount of income, the loan balance, the amount of assets held, and the amount of tax deduction. Examples of the numerical data other than the amount of money include data indicating various activities of the subject such as sleep time, working hours, and exercise time, and data indicating the health condition of the subject such as weight, blood pressure, and blood glucose level.

The content information indicating the content of the numerical data may be displayed or recorded in association with the numerical data, or may be acquired separately from the numerical data. The content information may be, for example, text data indicating the content of numerical data in a natural language, or data such as an image indicating the content of numerical data. In a case where data such as an image is used as the content information, the language model to be used may be a model that can use data such as an image as input data.

Here, learning the natural language more specifically means learning the arrangement of the components (words and the like) in the sentence of the natural language and the arrangement of the sentences in a text. Examples of the language model trained on natural language include bidirectional encoder representations from transformers (BERT), robustly optimized BERT approach (ROBERTa), efficiently learning an encoder that classifies token replacements accurately (ELECTRA), and the like.

The language model may be a general-purpose language model that can be used for applications other than the classification of numerical data, or may be a general-purpose language model finely tuned for the classification of numerical data. The language model may be included in the information processing apparatus 1 or may be included in another apparatus. In the latter case, the classification unit 101 uses the language model via another device including the language model.

The support information generation unit 102 generates the support information using the numerical data regarding the life plan of the subject as the data of the data items classified by the classification unit 101.

Here, the support information may be information that can be generated using data of a predetermined data item and can be used to support the life planning of the subject. For example, the support information may be information indicating a simulation result of future revenue and expenditure of the subject. Such a simulation can be performed using the current income amount and expenditure amount of the subject.

The support information may be information to be presented to the subject, or may be intermediate information used for generating information to be presented to the subject. For example, the current amount of revenue, the expenditure amount, the amount of assets held, and the breakdown thereof of the subject can be used for life planning of the subject and can be generated using data of a predetermined data item (for example, data of the income amount and the expenditure amount). Therefore, the support information generation unit 102 may generate support information indicating such an amount of money.

For example, in a case of generating the support information indicating a breakdown of the expenditure amount, the classification unit 101 uses numerical data indicating the expenditure amount in each expenditure of the subject and content information indicating the content of each expenditure to classify the numerical data into data items (for example, housing cost, food cost, and the like) associated with each breakdown of the expenditure amount. Then, the support information generation unit 102 generates the support information indicating the breakdown of the expenditure amount of the subject by using the numerical data indicating the expenditure amount in each expenditure of the subject as the data associated with the breakdown classified by the classification unit 101.

As described above, the information processing apparatus 1 according to the present exemplary example embodiment employs a configuration including the classification unit 101 that classifies a plurality of numerical data related to the life plan of the subject into each data item for generating the support information for supporting the life planning of the subject using the content information indicating the content of each numerical data and the language model trained by machine learning on natural language, and the support information generation unit 102 that generates the support information using the numerical data as data of the data item classified by the classification unit 101.

According to the above configuration, the plurality of pieces of numerical data related to the life plan are classified into the predetermined data items without human intervention, and the support information is automatically generated based on the classification result. Therefore, according to the above configuration, it is possible to obtain an effect of reducing the burden of work manually in life planning.

According to the information processing apparatus 1, it is also possible to support the decision-making of the subject by the generated support information. The information processing apparatus 1 can also be used for healthcare. For example, the information processing apparatus 1 can also generate support information indicating transition of medical expenses. By presenting such support information to the subject, it is possible to encourage the subject to be conscious of health management.

### (Support Program)

The functions of the information processing apparatus 1 described above can also be achieved by a program. A support program according to the present exemplary example embodiment is a support program for life planning causing a computer to function as classification means for classifying a plurality of pieces of numerical data related to a life plan of a subject into data items for generating support information for supporting life planning of the subject by using content information indicating content of each piece of numerical data and a language model trained by machine learning on natural language, and support information generation means for generating the support information by using the numerical data as data of data items classified by the classification means. According to this support program, it is possible to obtain an effect of reducing the burden of manual work in life planning.

### (Flow of Support Method)

A flow of a support method according to the present exemplary example embodiment will be described with reference to FIG. 2. FIG. 2 is a flowchart illustrating a flow of the support method. An executing entity of each step in this support method may be a processor included in the information processing apparatus 1, may be a processor included in another apparatus, or an executing entity of each step may be a processor provided in each of different apparatuses.

In S1 (classification processing), at least one processor classifies a plurality of pieces of numerical data related to the life plan of the subject into data items for generating support information for supporting the life planning of the subject by using content information indicating content of each piece of numerical data and a language model trained by machine learning on a natural language.

In S2 (support information generation processing), at least one processor generates support information by using the numerical data as data of data items classified in the classification processing of S1.

As described above, the support method according to the present exemplary example embodiment is a support method for life planning in which at least one processor includes classification processing for classifying a plurality of pieces of numerical data related to a life plan of a subject into data items for generating support information for supporting life planning of the subject by using content information indicating content of each piece of numerical data and a language model trained by machine learning on natural language, and support information generation processing for generating the support information by using the numerical data as data of data items classified by the classification processing. Therefore, according to the support method according to the present example embodiment, it is possible to obtain an effect of reducing the burden of manual work in life planning.

### Second Exemplary Example Embodiment

A second exemplary example embodiment that is an example embodiment of the present invention will be described in detail with reference to the drawings. Components having the same functions as the components described in the above-described exemplary example embodiment will be denoted by the same reference numerals, and the description thereof will be appropriately omitted. An application range of each technique adopted in the present exemplary example embodiment is not limited to the present exemplary example embodiment. That is, each technique adopted in the present exemplary example embodiment can also be adopted in the other exemplary example embodiments included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### (Outline of Information Processing Apparatus 1A)

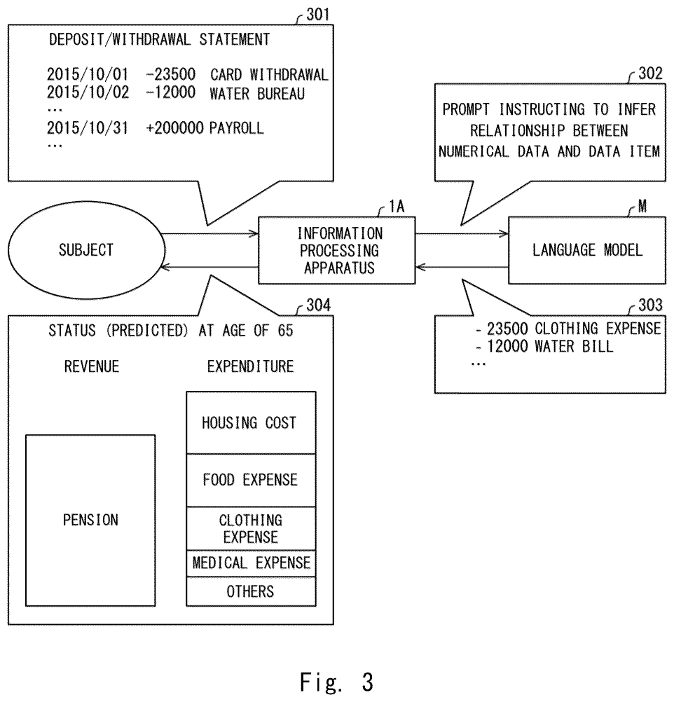

An outline of an information processing apparatus 1A according to the present exemplary example embodiment will be described with reference to FIG. 3. FIG. 3 is a diagram illustrating an example of processing executed by the information processing apparatus 1A.

In the example of FIG. 3, the subject inputs a deposit/withdrawal statement 301 to the information processing apparatus 1A. In the deposit/withdrawal statement 301, the amount of deposit/withdrawal in the account of the subject is indicated, and the date of deposit or withdrawal and the character string indicating the content of deposit or withdrawal are indicated as information related to the amount. The information processing apparatus 1A acquires the amount indicated in the deposit/withdrawal statement 301 as numerical data, and acquires the character string as content information indicating the content of the numerical data.

Next, the information processing apparatus 1A classifies the acquired numerical data into data items for generating support information for supporting life planning of the subject by using the acquired content information and the language model M trained by machine learning on natural language.

Specifically, the information processing apparatus 1A generates a prompt 302 including the acquired content information and the data item and instructing to infer a relationship between the numerical data and the data item. Then, the information processing apparatus 1A inputs the generated prompt 302 to the language model M and outputs the inference result 303. The inference result 303 in the example of FIG. 3 indicates whether each of the deposit/withdrawal items illustrated in the deposit/withdrawal statement 301 is associated with a predetermined data item (which can also be referred to as a classification category) in revenue and expenditure.

Next, the information processing apparatus 1A generates the support information 304 using the inference result 303 and presents the generated support information 304 to the subject. The support information 304 in the example of FIG. 3 is information indicating predicted values of an income amount and an expenditure amount of the subject at the age of 65 and a breakdown thereof. The support information 304 is generated using the income amount and the expenditure amount of each data item indicated in the inference result 303.

As described above, according to the information processing apparatus 1A, the subject receives the presentation of the support information 304 only by inputting the deposit/withdrawal statement 301 to the information processing apparatus 1A, and can perform his/her life planning with reference to the presentation of the support information. As described above, according to the information processing apparatus 1A, it is possible to reduce the burden of manual work in life planning.

### (Configuration of Information Processing Apparatus 1A)

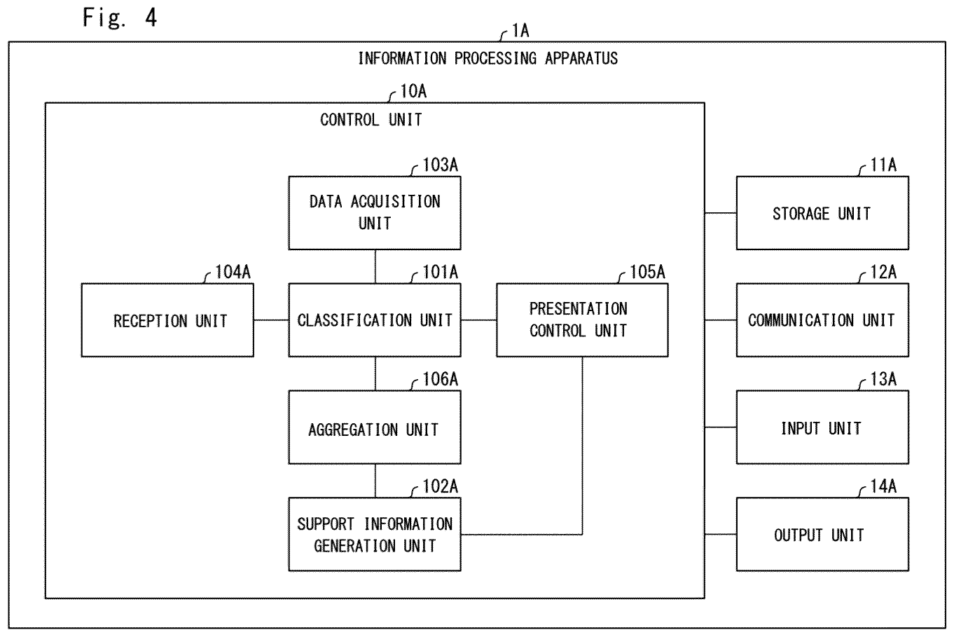

A configuration of an information processing apparatus 1A according to the present exemplary example embodiment will be described with reference to FIG. 4. FIG. 4 is a block diagram illustrating a configuration of the information processing apparatus 1A. The information processing apparatus 1A is a device having a function of supporting life planning. The information processing apparatus 1A may be a local apparatus used by individual users, or may be a server that provides life planning support services to a plurality of users.

As illustrated, the information processing apparatus 1A includes a control unit 10A that integrally controls units of the information processing apparatus 1A, and a storage unit 11A that stores various types of data to be used by the information processing apparatus 1A. The information processing apparatus 1A includes a communication unit 12A for the information processing apparatus 1A to communicate with another apparatus, an input unit 13A that receives an input to the information processing apparatus 1A, and an output unit 14A for the information processing apparatus 1A to output data. The control unit 10A includes a classification unit 101A, a support information generation unit 102A, a data acquisition unit 103A, a reception unit 104A, a presentation control unit 105A, and an aggregation unit 106A.

Similarly to the classification unit 101 of the first exemplary example embodiment, the classification unit 101A classifies the plurality of numerical data related to the life plan of the subject into each data item for generating the support information for supporting the life planning of the subject using the content information indicating the content of each numerical data and the language model M trained by machine learning on a natural language. In the present exemplary example embodiment, an example in which the language model M is a model that accepts an input of a prompt in a text format described in a natural language and outputs an answer in the natural language will be described. However, the language model M may be a model capable of accepting input of data in a format other than text data such as an image.

Similarly to the support information generation unit 102 of the first exemplary example embodiment, the support information generation unit 102A generates the support information using the numerical data regarding the life plan of the subject as the data of the data item classified by the classification unit 101. The support information generated by the support information generation unit 102A is not limited to the support information 304 illustrated in FIG. 3 as long as the support information directly or indirectly supports the life planning of the subject.

The data acquisition unit 103A acquires various data necessary for life planning support of the subject. For example, the data acquisition unit 103A acquires numerical data to be classified by the classification unit 101A, content information indicating the content, and the like. A data acquisition method by the data acquisition unit 103A is any method. For example, the data acquisition unit 103A may acquire data input via the input unit 13A, or may acquire data from another device via the communication unit 12A. For example, the data acquisition unit 103A may acquire numerical data or content information by performing character recognition on image data obtained by scanning a receipt or the like. The character recognition may be executed by a device other than the information processing apparatus 1A.

The reception unit 104A receives various instructions related to life planning support of the subject. For example, the reception unit 104A receives a correction instruction for a result of inference by the language model M. Any method of receiving the instruction is applicable. For example, the reception unit 104A may receive an instruction input via the input unit 13A, or may receive an instruction from another device via the communication unit 12A.

The presentation control unit 105A presents various types of information regarding the life planning support of the subject. For example, the presentation control unit 105A presents the support information generated by the support information generation unit 102A. For example, the presentation control unit 105A presents the inference result output by the language model M. Although details will be described later, the presentation control unit 105A may present the inference result together with the basis of the inference. Any method of presenting the information is applicable. For example, the presentation control unit 105A may present information by causing the output unit 14A to output the information, or may present information by causing another device to output the information via the communication unit 12A. The information can be presented in any form such as display, printing, voice, or a combination thereof.

The aggregation unit 106A aggregates a plurality of pieces of numerical data acquired by the data acquisition unit 103A for each data item classified by the classification unit 101A. Although details will be described later, a result of aggregation by the aggregation unit 106A is used for generation of the support information by the support information generation unit 102.

The aggregation method by the aggregation unit 106A may be a method according to the application of the aggregation result. The aggregation unit 106A may aggregate the numerical data by a different method for each data item. For example, in a case of generating the support information indicating the expenditure amount for each predetermined data item, the data acquisition unit 103A may aggregate the amounts by summing the amounts classified in the same data item. For example, in a case of generating the support information indicating the average expenditure amount in the predetermined period, the aggregation unit 106A may calculate the average value of the expenditure amount in the period.

As described above, the information processing apparatus 1A includes the classification unit 101A that classifies the plurality of pieces of numerical data related to the life plan of the subject into the data items for generating the support information for supporting the life planning of the subject using the content information indicating the content of each piece of numerical data and the language model M trained by machine learning on natural language, and the support information generation unit 102A that generates the support information using the numerical data related to the life plan of the subject as the data of the data items classified by the classification unit 101A. Therefore, similarly to the information processing apparatus 1, it is possible to obtain an effect of reducing the burden of manual work in life planning.

As described above, the information processing apparatus 1A includes the aggregation unit 106A that aggregates the plurality of numerical data for each data item classified by the classification unit 101A, and the support information generation unit 102A generates the support information by using a result of aggregation by the aggregation unit 106A. As a result, in addition to the effect obtained by the information processing apparatus 1, it is possible to obtain an effect that the support information reflecting the aggregation result of the numerical data can be generated without manually performing complicated work of aggregating the numerical data for each data item.

### (Example of Prompt and Inference Result)

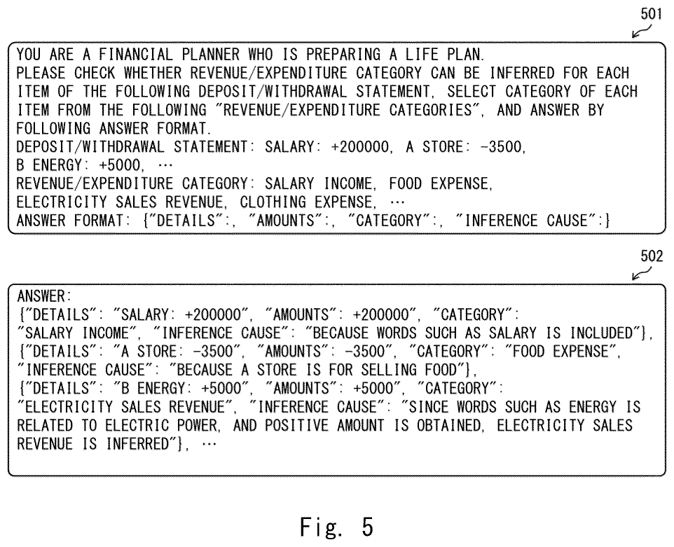

FIG. 5 is a diagram illustrating an example of a prompt generated by the classification unit 101A and an inference result obtained by inputting the prompt into the language model M.

A prompt 501 illustrated in FIG. 5 is a prompt to instruct to infer a relationship between each item (including numerical data) in the deposit/withdrawal statement and the “revenue/expenditure category” which is a data item used to generate the support information. The prompt 501 includes a sentence “You are a financial planner who is preparing a life plan.”. It is not essential to include such a sentence, but the inference accuracy can be expected to be improved by including such a sentence.

The prompt 501 is a content instructing to check whether the revenue and expenditure category can be inferred for each item of the deposit/withdrawal statement. The expression in the prompt can be appropriately changed within a range in which a desired inference result can be obtained. For example, the classification unit 101A may generate a prompt having different expressions of inference instructions according to target numerical data or content information, a data item of a classification category, a language model to be used, and the like.

The prompt 501 includes an “answer format” and has contents instructing to answer in this answer format. In this way, by specifying the answer format, it is possible to obtain an inference result in a format that is easy to use for generating the support information. This answer format includes an item “inference basis”. By including such items, it is possible to cause the language model M to output the inference result and the grounds of the inference. The instruction to output the grounds of inference may be made by including a text such as “Please answer the grounds together with the inference result” in the prompt, for example.

The prompt 501 may include a text specifying an output condition. For example, a text such as “it is necessary to infer the revenue and expenditure categories for all items of the deposit/withdrawal statement” or “The number of elements included in the answer format needs to match the number of items in the deposit/withdrawal statement.” may be included in the prompt 501. This makes it possible to increase the accuracy of the output of the language model M.

In the prompt 501, contents other than the “deposit/withdrawal statement” are fixed. Therefore, contents other than the “deposit/withdrawal statement” may be stored in the storage unit 11A or the like as a regular template. As a result, the classification unit 101A can input numerical data (indicating the amount of money of the deposit/withdrawal) and content information (indicating the content of the deposit/withdrawal) indicated in the deposit/withdrawal statement acquired by the data acquisition unit 103A to the template and generate the prompt 501.

The inference result 502 illustrated in FIG. 5 illustrates an example of an inference result obtained by inputting the prompt 501 to the language model M. The inference result 502 indicates a result of inferring a relationship between each item (including numerical data) in the deposit/withdrawal statement and the “revenue/expenditure category” which is a data item used to generate the support information in the form of the answer format indicated in the prompt 501. Specifically, in the inference result 502, each item in the deposit/withdrawal statement is associated with a “revenue/expenditure category” corresponding to the item. Therefore, the classification unit 101A can classify each numerical data based on the inference result 502.

The prompt 501 in FIG. 5 is a prompt for collectively classifying a plurality of pieces of numerical data, but classification may be performed for each piece of numerical data. In this case, the classification unit 101A may perform processing of inputting the numerical data and one of the data items of the classification category to the language model M for one numerical data and determining whether the numerical data is associated with the data item for each of the plurality of data items. By performing such processing on each numerical data, each numerical data can be classified into an associated data item. The classification unit 101A may perform processing of inputting one piece of numerical data and each data item of the classification category to the language model M and determining which one of the data items the numerical data is associated with, for each of the plurality of pieces of numerical data.

The classification unit 101A may perform processing of inputting one data item and one numerical data to the language model M for one of the data items of the classification category and determining whether the numerical data is associated with the data item for each of the plurality of numerical data. By performing such processing on each data item, each numerical data can be classified into the associated data item. The classification unit 101A may perform processing of inputting one data item and a plurality of numerical data to the language model M and determining which of the plurality of numerical data is associated with the data item, for each of the plurality of data items. In any case, the content information indicating the content of the numerical data is input to the language model M.

In what form the inference result is output can be specified by a prompt. For example, the classification unit 101A may generate a prompt for instructing to answer with three choices of belonging to the data item, being neutral, and not belonging to the data item. In this case, in a case an answer indicating that certain numerical data belongs to a certain data item is output, the classification unit 101A may classify the numerical data into the data item. What kind of processing is to be performed in a case where a neutral response is output may be determined in advance. For example, in a case where an answer of neutrality is output in response to a prompt asking whether certain numerical data belongs to a certain data item, the presentation control unit 105A may present a combination of the numerical data and the data item to the subject and cause the subject to input whether the numerical data belongs to the data item. For example, the classification unit 101A may generate a prompt for instructing to output a numerical value (for example, a numerical value of 0 to 1) indicating the degree of possibility of belonging to the data item. In this case, the classification unit 101A may classify the numerical data into data items in which the output numerical value is equal to or more than a predetermined threshold.

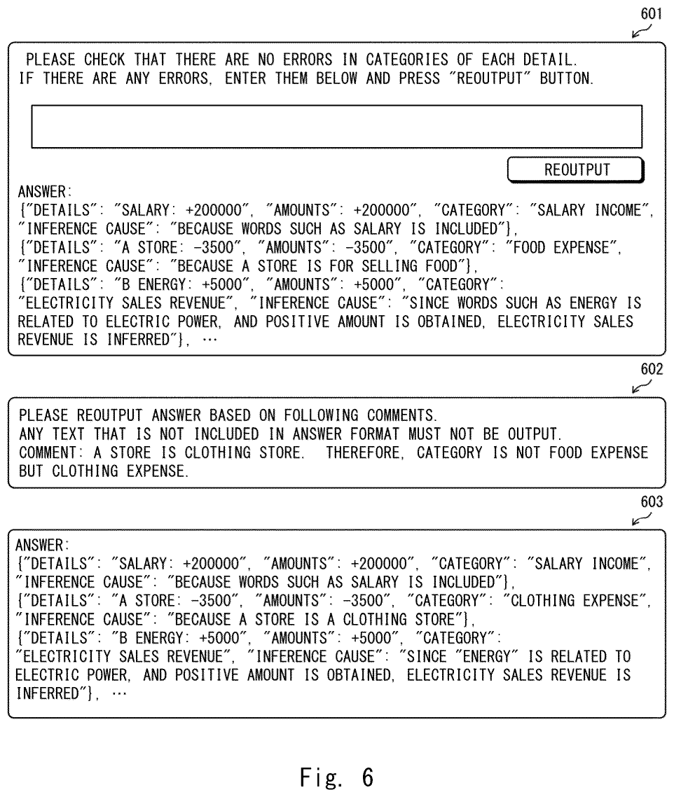

In the inference result 502, the grounds of inference are indicated. Although details will be described later with reference to FIG. 6, the basis of the inference is presented to the subject by the presentation control unit 105A as a material for determining whether the inference result is appropriate.

As described above, the classification unit 101A may generate a prompt that includes the content information indicating the content of the numerical data and the data item for generating the support information and instructs to infer the relationship between the numerical data and the data item, and classify the numerical data based on the output obtained by inputting the generated prompt to the language model M. This makes it possible to appropriately classify each numerical data.

### (Presentation and Reclassification of Inference Result)

The result of the inference of the language model M is not necessarily correct. For this reason, the results of the inference of the language model M may be presented to the subject, and the subject may be asked to confirm whether there is an error in the results. Then, in a case where there is an error, the subject may correct the error, and the numerical data may be reclassified by reflecting the correction. This will be described with reference to FIG. 6. FIG. 6 is a diagram illustrating presentation and reclassification of an inference result.

A screen example 601 in FIG. 6 is an example of a user interface (UI) screen that presents an inference result and receives a correction instruction. In the screen example 601, the inference result 502 illustrated in FIG. 5 is illustrated, and at the same time, a text that prompts the user to confirm whether there is an error in the inference result and requests the user to input the content of the error and instruct re-output is illustrated. A text box for inputting the correction content and a button (software key) for instructing re-output are also displayed in the screen example 601.

The presentation control unit 105A can cause the subject to confirm the inference result by presenting the UI screen such as the screen example 601 to the subject. The reception unit 104A can also receive correction for the inference result via a UI screen such as the screen example 601. In a case where the output unit 14A has a function of displaying and outputting an image, the presentation control unit 105A may cause the output unit 14A to display a UI screen. The presentation control unit 105A may cause a display device (for example, a display device included in a terminal device used by the subject) outside the information processing apparatus 1A to display the UI screen via the communication unit 12A.

In the screen example 601, in a case where a correction content is input into the text box and a button for instructing re-output is operated, the reception unit 104A receives the input correction content as a correction instruction. For example, the reception unit 104A may receive a correction instruction including a correct revenue/expenditure category and a reason why the inference result is an error. In this case, the presentation control unit 105A may display a pull-down list listing each of the revenue and expenditure categories and cause the subject to select a correct revenue and expenditure category.

Then, the classification unit 101A re-classifies the numerical data based on the correction instruction received by the reception unit 104A. For example, the classification unit 101A may generate a prompt 602 illustrated in FIG. 6, input the prompt to the language model M, and reclassify the numerical data based on the re-inference result 603 output from the language model M.

The prompt 602 includes the correction instruction received by the reception unit 104A, and is a prompt to instruct to infer the relationship between the numerical data and the data item based on the correction instruction. The prompt 602 includes a text “any text is not included in answer format must not be output.”. In this manner, the prompt for instructing re-inference may also include a text specifying an output condition. As a result, it is possible to prevent unnecessary content (for example, texts such as “Sorry. I will output again.” and “Contents have been updated.”) from being output from the language model M, and to prevent generation of the support information from being hindered. The prompt 602 can also be generated using a predetermined template similarly to the prompt 501 illustrated in FIG. 5. Similarly to the prompt 501, the deposit/withdrawal statement, the revenue/expenditure category, and the answer format may be described in the prompt 602.

In the re-inference result 603 illustrated in FIG. 6, as compared with the inference result 502 illustrated in FIG. 5, the “category” of the “A store” has been changed to the “clothing expense”, and the inference basis has been changed to a sentence “Because the A store is a clothing store”. As described above, the re-inference is performed using the prompt 602 including the sentence in the natural language received as the correction instruction, in such a way that the re-inference result 603 reflecting the content of the correction instruction can be output.

As described above, the classification unit 101A may generate a prompt for instructing to output the basis of the inference together with the inference result of the relationship between the numerical data related to the life planning subject and the data item for generating the support information for supporting the life planning of the subject. Then, the presentation control unit 105A may present the inference result output by the language model M together with the basis. As a result, in addition to the effect obtained by the information processing apparatus 1, it is possible to obtain an effect that the appropriateness/inappropriateness of the inference result of the language model M can be examined using the basis thereof as a determination material. The presentation control unit 105A may present the classification result of the classification unit 101A instead of the inference result output by the language model M.

As described above, the information processing apparatus 1A includes the reception unit 104A that receives a correction instruction for the inference result. Then, the classification unit 101A re-classifies the numerical data based on the correction instruction received by the reception unit 104A. As a result, in addition to the effect obtained by the information processing apparatus 1, it is possible to correct an error in the inference result and generate appropriate support information.

As described above, the reception unit 104A may receive a correction instruction representing a correction content in a natural language. In this case, the classification unit 101A generates a prompt that includes the correction instruction received by the reception unit 104A and instructs to infer the relationship between the numerical data and the data item based on the correction instruction, and reclassifies the numerical data based on the output obtained by inputting the generated prompt to the language model M. As a result, in addition to the effect obtained by the information processing apparatus 1, it is possible to perform appropriate reclassification by considering the intention of the correction instruction.

For example, even if the comment of the correction instruction in the example of FIG. 6 does not include the correct category of “clothing expenses” such as “A store is a clothing store” or “I bought a shirt at A store”, it is possible to infer the correct category of “clothing expenses” based on the content of the comment.

By accepting a correction instruction representing a correction content in a natural language, it is also possible to absorb notation distortion and collectively correct similar items. For example, it is assumed that “A store” described above is described as “Ei shoten” (in Japanese) in the deposit/withdrawal statement in the bank account, and is described as “A shoten” (in Japanese) in the statement of credit card. In such a case as well, if a correction instruction indicating that “A store” is a clothing store is input, both of the expenditure for “Ei shoten” in the deposit/withdrawal statement in the bank account and the expenditure for “A shoten” in the credit card statement can be classified as “clothing expenses”. For example, it is also possible to collectively correct classifications of a plurality of stores having the same name, such as “A store X branch” and “A store Y branch”, based on a correction instruction for “A store”.

### (Reuse of Correction Instruction)

The content of the correction instruction as described above may be recorded in the storage unit 11A or an external database or the like and used for the subsequent inference. For example, a comment of a correction instruction of “The A store is a clothing store. Therefore, the category is not food expenses but clothing expenses.” input at the time of classifying certain numerical data may be recorded, and this comment may also be used for classifying other numerical data. As a result, “A store” can be correctly classified into “clothing expenses” also in the subsequent classification (the classification may be limited to the same subject or may be applied to the classification of other subjects).

The presentation control unit 105A may present the recorded content of the correction instruction to the subject, and the reception unit 104A may receive correction, deletion, addition, or the like of the content of the correction instruction. As a result, the content of the correction instruction according to the intention of the subject can be reflected in the subsequent classification without relearning the language model M or the like. The correction instruction may be reused by including the correction instruction in the prompt as in the case where the correction instruction is used for the first time. That is, the classification unit 101A may generate a prompt that includes the recorded correction instruction and instructs to infer the relationship between the numerical data and the data item based on the correction instruction, and classify the numerical data based on the output obtained by inputting the generated prompt to the language model M.

### (Flow of Processing)

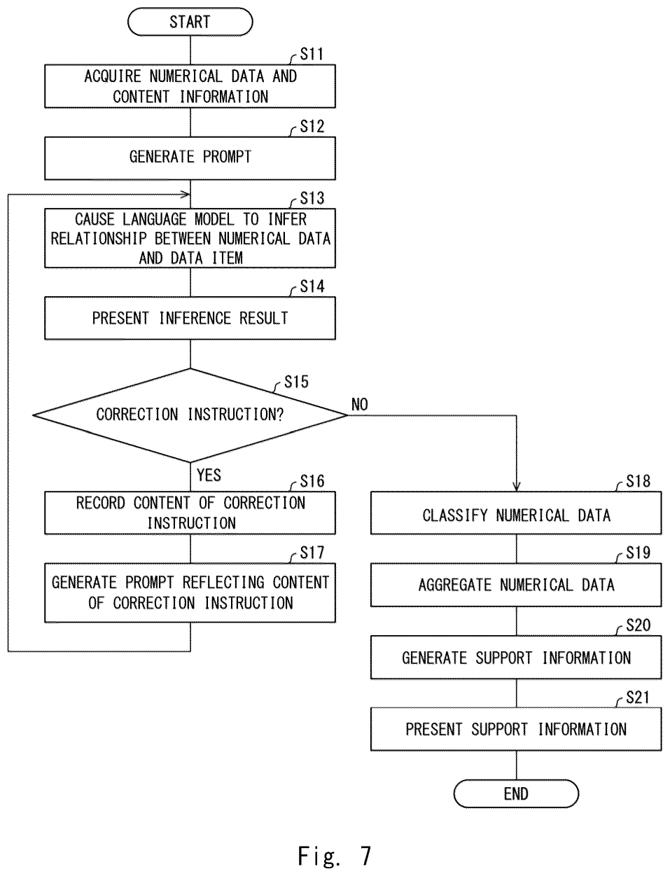

A flow of processing executed by the information processing apparatus 1A will be described with reference to FIG. 7. FIG. 7 is a flowchart illustrating a flow of processing executed by the information processing apparatus 1A. The flowchart of FIG. 7 includes each processing of the support method according to the present exemplary example embodiment.

In S11, the data acquisition unit 103A acquires numerical data to be classified by the classification unit 101A and content information indicating the content thereof. For example, the data acquisition unit 103A may acquire a deposit/withdrawal statement (including numerical data and content information) of the subject via the input unit 13A or the communication unit 12A.

In S12, the classification unit 101A generates a prompt to be input to the language model M. Specifically, the classification unit 101A generates a prompt including the numerical data and the content information acquired in S11 and the predetermined data item for generating the support information for supporting the life planning of the subject, and instructing to infer the relationship between the numerical data and the data item.

In S13, the classification unit 101A inputs the prompt generated in S12 to the language model M to infer the relationship between the numerical data and the data item. In S14, the presentation control unit 105A presents the inference result of S13 to the subject. In S15, the reception unit 104A determines the presence or absence of a correction instruction for the inference result presented in S14.

In S14, the presentation control unit 105A may present the inference result by displaying a UI screen such as the screen example 601 of FIG. 6, for example. In this case, the reception unit 104A may receive the correction instruction via the UI screen. If YES is determined in S15, the processing proceeds to S16, and if NO is determined in S15, the processing proceeds to S18.

In S16, the reception unit 104A records the content of the received correction instruction in the storage unit 11A, an external database, or the like. Any timing of recording the content of the correction instruction is applicable. For example, the reception unit 104A may record the content of the correction instruction after classification described later is completed or after the support information is presented.

In S17, the classification unit 101A generates a prompt reflecting the content of the correction instruction received by the reception unit 104A, specifically, a prompt including the correction instruction and instructing to infer the relationship between the numerical data and the data item based on the correction instruction. Thereafter, the processing returns to S13, and the classification unit 101A inputs a newly generated prompt to the language model M to infer the relationship between the numerical data and the data item.

In S18, the classification unit 101A classifies the numerical data acquired in S11 based on the inference result of the language model M (the latest inference result among the plurality of inference results in a case where inference is performed a plurality of times). In the flowchart of FIG. 7, the processing of S12, S13, S17, and S18 is associated with the classification processing of classifying the plurality of numerical data related to the life plan of the subject into each data item for generating the support information for supporting the life planning of the subject using the content information indicating the content of each numerical data and the language model obtained by machine learning of the natural language.

In S19, the aggregation unit 106A aggregates the plurality of pieces of numerical data acquired in S11 for each data item classified in S18. In other words, the aggregation unit 106A aggregates a plurality of pieces of numerical data classified into the same data item.

In S20 (support information generation processing), the support information generation unit 102A generates support information using the numerical data acquired in S11 as data of the data items classified in S18. At this time, for the data item aggregated in S19, the support information generation unit 102A uses the aggregation result as data of the data item.

In S21, the presentation control unit 105A presents the support information generated in S20 to the subject. Accordingly, the processing of FIG. 7 ends.

### (Information for Generating Support Information)

By using various information other than the numerical data in addition to the numerical data as described above, it is possible to generate more satisfactory support information. For example, by using information indicating a family structure and a future design, the support information generation unit 102A can generate support information indicating a result of a simulation based on the information.

Each piece of information used to generate the support information including the numerical data may be obtained by interaction with the subject using the language model M. In this case, the information processing apparatus 1A may repeat processing of inputting text data indicating the content of the utterance of the subject to the language model M, generating an answer to the utterance, and presenting the generated answer to the subject. In a case where the answer is generated, it is possible to improve the accuracy of the answer by causing the language model M to refer to reliable material (for example, statistical information, reports, and the like provided and accumulated by insurance companies, governments, and the like) related to life planning. In a case of causing the language model M to generate an answer to the question, the information processing apparatus 1A may also cause the language model M to output the basis of the answer and present the output answer to the subject together with the basis.

In a case where the hobby of the subject can be gotten out by the dialogue as described above, for example, the support information generation unit 102A can generate the support information reflecting the hobby. For example, in a case where the hobby of the subject is riding on a motorcycle, it is also possible to generate support information including a simulation result in a case where the subject causes an accident on a motorcycle, and support information including introduction of insurance in which compensation for injury, property damage, and the like due to an accident on a motorcycle is heavy.

The conversation with the subject can also be performed after the presentation of the support information. For example, the information processing apparatus 1A may cause the subject to input an impression, a question, or the like with respect to the presented support information, and cause the language model M to generate and present an answer thereto. As a result, the understanding of the support information of the subject can be deepened, and the values and ideas of the subject can be clarified. Answers and questions to be presented to the subject can also be determined using a rule base.

The support information generation unit 102A may update the support information by using the information obtained after the presentation of the support information, or may make a new proposal (for example, a proposal for an insurance plan or a financial product) by using the information obtained after the presentation of the support information. At that time, the information processing apparatus 1A may generate a summary of the values and ideas of the subject from the utterance content of the subject using the language model M, and present the summary to the subject as reference information. At that time, each sentence included in the summary and the utterance of the subject corresponding thereto may be presented in association with each other, and it may be possible to easily confirm whether the summary meets the intention of the subject.

The subject can re-create the support information at any timing. The subject can also generate a plurality of pieces of support information while changing the input information (for example, revenue, a change rate thereof, a retirement age, the number of children, a school destination, and the like). As a result, the subject can simulate the life plan according to the revenue, the change, and the like.

The information processing apparatus 1A can recommend a change in insurance or the like in accordance with a change in the life plan of the subject. The support information generated by the information processing apparatus 1A is reference information, and is not necessarily correct. Therefore, the information processing apparatus 1A may present the generated support information, present information for introducing a financial planner or an insurance sales representative, or accept a reservation for an interview with such a person.

The information processing apparatus 1A may start monitoring the revenue and expenditure of the subject after generating the support information including the simulation result of the future revenue and expenditure of the subject. As a result, in a case where there is a difference between the simulation result indicated in the previously generated support information and the actual revenue and expenditure, the support information generation unit 102A can generate support information indicating the difference and cause the presentation control unit 105A to present the generated support information to the subject.

As a result, it is possible to cause the subject to recognize that it is necessary to review the life plan, and it is possible to cause the subject to consider coping at an early stage. The information regarding the revenue and expenditure of the subject (for example, salary income change, withdrawal amount, management revenue, loan balance, interest rate change, and the like) can be acquired in cooperation with, for example, a bank account, a securities account, a credit card system, or the like of the subject. In particular, since the information processing apparatus 1A can automatically classify the numerical data, it is possible to automatically and accurately detect that the life plan needs to be reviewed.

### Modified Examples

An executing entity of each processing described in the above-described example embodiments is optional, and is not limited to the above-described examples. For example, a system having functions similar to those of the information processing apparatuses 1 and 1A can be constructed by a plurality of apparatuses capable of communicating with each other. The execution subject of each processing illustrated in the flowchart illustrated in FIG. 7 may be one device (also referred to as a processor) or a plurality of devices (also referred to as a processor).

### [Example of Implementation by Software]

Some or all of the functions of the information processing apparatuses 1 and 1A (hereinafter, also referred to as “each of the above apparatuses”) may be implemented by hardware such as an integrated circuit (IC chip) or may be implemented by software.

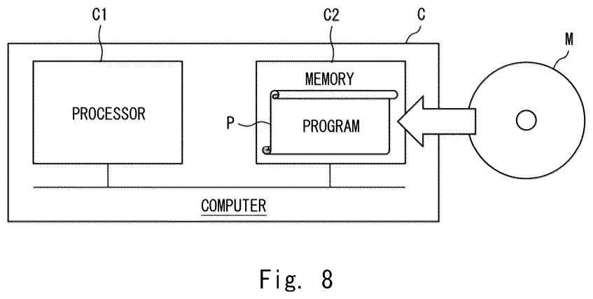

In the latter case, each of the above apparatuses is implemented by, for example, a computer that executes a command of a program which is software for implementing each function. An example of such a computer (hereinafter, referred to as a computer C) is illustrated in FIG. 8. FIG. 8 is a block diagram illustrating a hardware configuration of the computer C functioning as each of the above apparatuses.

The computer C includes at least one processor C1 and at least one memory C2. A program (support program) P for operating the computer C as each of the above apparatuses is recorded in the memory C2. In the computer C, the processor C1 reads the program P from the memory C2 and executes the program P to implement each function of each of the above apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other apparatuses. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be implemented by one processor provided in one computer, may be implemented in cooperation with a plurality of processors provided in one computer, or may be implemented in cooperation with a plurality of processors provided in a plurality of computers, respectively. The program causing each of the above apparatuses to implement each of the above functions may be stored in one memory provided in one computer, may be stored in a distributed manner in a plurality of memories provided in one computer, or may be stored in a distributed manner in a plurality of memories provided in a plurality of computers, respectively.

### [Supplementary Notes]

The present disclosure includes the technologies described in the following supplementary notes. However, the present invention is not limited to the techniques described in the following supplementary notes, and various modifications can be made within the scope described in the claims.

### (Supplementary Note A1)

An information processing apparatus including: classification means for classifying a plurality of pieces of numerical data related to a life plan of a subject into data items for generating support information for supporting life planning of the subject by using content information indicating content of each piece of numerical data and a language model trained by machine learning on natural language; and support information generation means for generating the support information by using the numerical data as data of data items classified by the classification means.

### (Supplementary Note A2)

The information processing apparatus according to Supplementary Note A1, further including aggregation means for aggregating the plurality of pieces of numerical data for each data item classified by the classification means, in which the support information generation means generates the support information by using a result of aggregation by the aggregation means.

### (Supplementary Note A3)

The information processing apparatus according to Supplementary Note A1 or A2, in which the classification means generates a prompt that includes the content information and the data item and instructs to infer a relationship between the numerical data and the data item, and classifies the numerical data based on an output obtained by inputting the generated prompt to the language model.

### (Supplementary Note A4)

The information processing apparatus according to Supplementary Note A3, in which the classification means generates a prompt for instructing to output a basis of the inference together with an inference result of the relationship between the numerical data and the data item, and the information processing apparatus further includes presentation control means for presenting the inference result output by the language model together with the basis.

### (Supplementary Note A5)

The information processing apparatus according to Supplementary Note A4, further including reception means for receiving a correction instruction for the inference result, in which the classification means reclassifies the numerical data based on the correction instruction received by the reception means.

### (Supplementary Note A6)

The information processing apparatus according to Supplementary Note A5, in which the reception means receives a correction instruction representing a correction content in a natural language, and the classification means generates a prompt including a correction instruction received by the reception means and instructing to infer a relationship between the numerical data and the data item based on the correction instruction, and reclassifies the numerical data based on an output obtained by inputting the generated prompt to the language model.

### (Supplementary Note B1)

A support method causing at least one processor to execute: classification processing for classifying a plurality of pieces of numerical data related to a life plan of a subject into data items for generating support information for supporting life planning of the subject by using content information indicating content of each piece of numerical data and a language model trained by machine learning on natural language; and support information generation processing for generating the support information by using the numerical data as data of data items classified by the classification processing.

### (Supplementary Note B2)

The support method according to Supplementary Note B1, in which the at least one processor includes aggregation processing of aggregating the plurality of numerical data for each data item classified in the classification processing, and in the support information generation processing, the at least one processor generates the support information using a result of aggregation by the aggregation processing.

### (Supplementary Note B3)

The support method according to Supplementary Note B1 or B2, in which in the classification processing, the at least one processor generates a prompt that includes the content information and the data item and instructs to infer a relationship between the numerical data and the data item, and classifies the numerical data based on an output obtained by inputting the generated prompt to the language model.

### (Supplementary Note B4)

The support method according to Supplementary Note B3, in which in the classification processing, the at least one processor generates a prompt instructing to output a basis of the inference together with an inference result of the relationship between the numerical data and the data items, and the at least one processor includes presentation control processing of presenting the inference result output by the language model together with the basis.

### (Supplementary Note B5)

The support method according to Supplementary Note B4, in which the at least one processor executes reception processing of receiving a correction instruction for the inference result, and the at least one processor reclassifies the numerical data based on the correction instruction received in the reception processing.

### (Supplementary Note B6)

The support method according to Supplementary Note B5, in which in the reception processing, the at least one processor receives a correction instruction representing a correction content in a natural language, and the at least one processor generates a prompt including the correction instruction received in the reception processing and instructing to infer a relationship between the numerical data and the data items based on the correction instruction, and reclassifies the numerical data based on an output obtained by inputting the generated prompt to the language model.

### (Supplementary Note C1)

A support program causing a computer to function as: classification means for classifying a plurality of pieces of numerical data related to a life plan of a subject into data items for generating support information for supporting life planning of the subject by using content information indicating content of each piece of numerical data and a language model trained by machine learning on natural language; and support information generation means for generating the support information by using the numerical data as data of data items classified by the classification means.

### (Supplementary Note C2)

The support program according to Supplementary Note C1, further causing the computer to function as aggregation means for aggregating the plurality of pieces of numerical data for each data item classified by the classification means, in which the support information generation means generates the support information by using a result of aggregation by the aggregation means.

### (Supplementary Note C3)

The support program according to Supplementary Note C1 or C2, in which the classification means generates a prompt that includes the content information and the data item and instructs to infer a relationship between the numerical data and the data item, and classifies the numerical data based on an output obtained by inputting the generated prompt to the language model.

### (Supplementary Note C4)

The support program according to Supplementary Note C3, in which the classification means generates a prompt for instructing to output a basis of the inference together with an inference result of the relationship between the numerical data and the data item, and the support program further causes the computer to function as presentation control means for presenting the inference result output by the language model together with the basis.

### (Supplementary Note C5)

The support program according to Supplementary Note C4, further causing the computer to function as reception means for receiving a correction instruction for the inference result, in which the classification means reclassifies the numerical data based on the correction instruction received by the reception means.

### (Supplementary Note C6)

The support program according to Supplementary Note C5, in which the reception means receives a correction instruction representing a correction content in a natural language, and the classification means generates a prompt including a correction instruction received by the reception means and instructing to infer a relationship between the numerical data and the data item based on the correction instruction, and reclassifies the numerical data based on an output obtained by inputting the generated prompt to the language model.

### (Supplementary Note D1)

An information processing apparatus including at least one processor, the at least one processor executing classification processing for classifying a plurality of pieces of numerical data related to a life plan of a subject into data items for generating support information for supporting life planning of the subject by using content information indicating content of each piece of numerical data and a language model trained by machine learning on natural language; and support information generation processing for generating the support information by using the numerical data as data of data items classified by the classification processing.

The information processing apparatus may further include a memory. The memory may store a program for causing the at least one processor to execute each of the processing.

### (Supplementary Note D2)

The information processing apparatus according to Supplementary Note D1, in which the at least one processor executes aggregation processing of aggregating the plurality of numerical data for each data item classified in the classification processing, and in the support information generation processing, the at least one processor generates the support information using a result of aggregation by the aggregation processing.

### (Supplementary Note D3)

The information processing apparatus according to Supplementary Note D1 or D2, in which in the classification processing, the at least one processor generates a prompt that includes the content information and the data item and instructs to infer a relationship between the numerical data and the data item, and classifies the numerical data based on an output obtained by inputting the generated prompt to the language model.

### (Supplementary Note D4)

The information processing apparatus according to Supplementary Note D3, in which in the classification processing, the at least one processor generates a prompt instructing to output a basis of the inference together with an inference result of the relationship between the numerical data and the data items, and the at least one processor executes presentation control processing of presenting the inference result output by the language model together with the basis.

### (Supplementary Note D5)

The information processing apparatus according to Supplementary Note D4, in which the at least one processor executes reception processing of receiving a correction instruction for the inference result, and the at least one processor reclassifies the numerical data based on the correction instruction received in the reception processing.

### (Supplementary Note D6)

The information processing apparatus according to Supplementary Note D5, in which in the reception processing, the at least one processor receives a correction instruction representing a correction content in a natural language, and the at least one processor generates a prompt including the correction instruction received in the reception processing and instructing to infer a relationship between the numerical data and the data items based on the correction instruction, and reclassifies the numerical data based on an output obtained by inputting the generated prompt to the language model.

### (Supplementary Note E)

A non-transitory recording medium recording a support program for causing a computer to function as an information processing apparatus, causing the computer to execute classification processing for classifying a plurality of pieces of numerical data related to a life plan of a subject into data items for generating support information for supporting life planning of the subject by using content information indicating content of each piece of numerical data and a language model trained by machine learning on natural language; and support information generation processing for generating the support information by using the numerical data as data of data items classified by the classification processing.

1. An information processing apparatus comprising:
at least one memory storing instructions; and
at least one processor configured to execute the instructions to;
classify a plurality of pieces of numerical data related to a life plan of a subject into data items for generating support information for supporting life planning of the subject by using content information indicating content of each piece of numerical data and a language model trained by machine learning on natural language; and
generate the support information by using the numerical data as data of data items classified by the classification means.

2. The information processing apparatus according to claim 1, wherein the at least one processor is further configured to execute the instructions to aggregate the plurality of pieces of numerical data for each data item; and
generate the support information by using a result of aggregation.

3. The information processing apparatus according to claim 1, wherein the at least one processor is further configured to execute the instructions to
generate a prompt that includes the content information and the data item and instructs to infer a relationship between the numerical data and the data item; and
classify the numerical data based on an output obtained by inputting the generated prompt to the language model.

4. The information processing apparatus according to claim 3, wherein the at least one processor is further configured to execute the instructions to
generate a prompt for instructing to output a basis of the inference together with an inference result of the relationship between the numerical data and the data item; and
present the inference result output by the language model or a classification result together with the basis.

5. The information processing apparatus according to claim 4, wherein the at least one processor is further configured to execute the instructions to
receive a correction instruction for the inference result; and
classify the numerical data based on the correction instruction.

6. The information processing apparatus according to claim 5 wherein the at least one processor is further configured to execute the instructions to
receive a correction instruction representing a correction content in a natural language;
generate a prompt including the correction instruction and instructing to infer a relationship between the numerical data and the data item based on the correction instruction; and
reclassify the numerical data based on an output obtained by inputting the generated prompt to the language model.

7. A support method causing at least one processor to execute:
classification processing for classifying a plurality of pieces of numerical data related to a life plan of a subject into data items for generating support information for supporting life planning of the subject by using content information indicating content of each piece of numerical data and a language model trained by machine learning on natural language; and
support information generation processing for generating the support information by using the numerical data as data of data items classified by the classification processing.

8. A non-transitory recording medium recording a support program for causing a computer to function as an information processing apparatus, causing the computer to execute:
classification processing for classifying a plurality of pieces of numerical data related to a life plan of a subject into data items for generating support information for supporting life planning of the subject by using content information indicating content of each piece of numerical data and a language model trained by machine learning on natural language; and
support information generation processing for generating the support information by using the numerical data as data of data items classified by the classification processing.
